(19) United States
(12) Patent Application Publication
(10) Pub. No.: US 2005/0256760 A1
(43) Pub. Date: Nov. 17, 2005

(54) System, method, and software for short term forecasting using predictive indicators

(76) Inventor: Ashok Siddhanti, McLean, VA (US)

Correspondence Address: FOLEY AND LARDNER;SUITE 500, 3000 K STREET NW, WASHINGTON, DC, 20007, US

(21) Appl. No.: 11/127,301

(22) Filed: May 12, 2005

Related U.S. Application Data
(60) Provisional application No. 60/570,068, filed on May 12, 2004.

(51) Int. Cl. G06F 17/60

(52) U.S. Cl. 705/10

(57) ABSTRACT

A computer implemented method, system, and software of making a short term forecast using tactical predictors, includes collecting predictor data related to the short term forecast, wherein the collecting predictor data includes identifying driver data that drives the forecast from a group consisting of demand drivers, supply drivers, competitive drivers, and environmental drivers. The predictor data related to the short term forecast is transformed; and the short term forecast is created based on the transformed predictor data.

### CROSS-REFERENCE TO RELATED PATENT APPLICATIONS

This application claims the benefit of priority under 35 U.S.C. §119(e) of provisional application No. 60/570,068 filed on May 12, 2004, the disclosure of which is incorporated herein in its entirety.

### FIELD OF THE INVENTION

The invention relates generally to a method, system, and software for short term forecasting using predictive indicators.

### BACKGROUND OF THE INVENTION

Majority of operating decision in a corporation or other organization span the near-term horizon-from now until 16 weeks (for example). Staff are hired or placed, items manufactured, inventory stocked, cash spent or stored based of forecasts of demand and supply. To the extent the forecasts are wrong, wrong number of staff get hired or placed on incorrect assignments, wrong items gets manufactured, wrong items get added to inventory.

Inaccurate forecasts lead to waste—of human capital, physical goods, and monetary resources.

For example, a drug store chain carries eight to nine weeks' inventory of an item, on average, on its books. The manufacturers of those items carry an additional six to seven weeks—for a total of fourteen or more weeks' inventory in the supply chain. And these may include day-to-day items—such as shaving gear, and cosmetics.

The waste of resources is pervasive, and occurs continuously. According to certain estimates, over $2B of inventory in the US is ‘written-off’ every year.

Call centers, banks, and several service operations have excess labor every hour, day and week—this excess labor is estimated at least 10%-12%.

Incorrect grades of crude oil are purchased-driving up the price of oil—only for the refined product to go into storage (over eight weeks of inventory are carried in the pipeline post the refinery stage). Therefore, inaccurate forecasts lead to costs and inefficiencies in almost all types of organizations whether they are manufacturers of products or provider of services, such as, call center services.

### SUMMARY OF THE INVENTION

In certain embodiments, the present application provides a computer implemented method of making a short term forecast using tactical predictors, including: collecting predictor data related to the short term forecast, wherein the collecting predictor data includes identifying driver data that drives the forecast from a group consisting of demand drivers, supply drivers, competitive drivers, and environmental drivers; transforming the predictor data related to the short term forecast; and creating a forecast based on the transformed predictor data.

In certain embodiments, the step of collecting predictor data comprises identifying demand drivers that influence demand timing or quantity of items being forecast, identifying supply drivers that directly influence supply timing or quantity of items being forecast, identifying competitive drivers representing competitor data that influences the items being forecast, and environmental drivers that represent environmental data that influences the supply, demand, or pricing of the items being forecast.

In certain embodiments, the step of collecting predictor data comprises selecting input data by determining the sensitivity of the forecast to the individual inputs and eliminating inputs that are correlated to the most sensitive inputs.

In certain embodiments, the step of transforming the predictor data includes processing the input data by one or more among a group consisting of: inter-variable processing, asynchronous input presentation, relative gradient inputs, stretching and scaling, cross-normalization, and adjusting non-zero values.

In certain embodiments, the step of creating a forecast comprises using an algorithm with lateral/simultaneous data input and using gradient tapping to determine a number of periods of data to be used.

In certain embodiments, the step of creating a forecast further includes performing parameter optimization. The step of performing parameter optimization may include training based optimization in which all of the training data is used to train a model that creates the forecast.

In certain embodiments, the step of creating the forecast includes using longer term forecasts as inputs into shorter term forecasts. In certain embodiments, the step of creating the forecast comprises using a relative gradient input from the longer term forecast into the shorter term forecast. In certain other embodiments, the step of using longer term forecasts as inputs into shorter term forecasts comprises aggregating the longest term forecasts to a higher level of aggregation.

In certain embodiments, the present invention provides a system for making a short term forecasting using tactical predictors, including: predictor data unit configured to collect predictor data related to the short term forecast, wherein collecting predictor data includes identifying driver data that drives the forecast from a group consisting of demand drivers, supply drivers, competitive drivers, and environmental drivers; data transformation unit that transforms the predictor data related to the short term forecast; and forecast creation unit configured to create the short term forecast based on the transformed predictor data.

In certain embodiments, the present invention provides a computer program product on a computer readable medium, that when executed on a computing system, generates a short term forecast using tactical predictors, including:
code for collecting predictor data related to the short term forecast, wherein the collecting predictor data includes identifying driver data that drives the forecast from a group consisting of demand drivers, supply drivers, competitive drivers, and environmental drivers;
code for transforming the predictor data related to the short term forecast; and
creating the short term forecast based on the transformed predictor data.

### BRIEF DESCRIPTION OF THE DRAWINGS

The accompanying drawings, which are incorporated in and constitute a part of the specification, illustrate a presently preferred embodiment(s) of the invention, and, together with the general description given above and the detailed description given below, serve to explain the principles of the invention.

FIG. 1 is flow diagram that illustrates the steps of one embodiment of the present invention.

FIG. 2 is a component diagram that illustrates the forecasting method in certain embodiments.

FIG. 3 is a listing of predictive drivers used in one embodiment that forecasts units.

FIG. 4 is diagram illustrating data transformation steps.

FIG. 5 discloses data warehousing features.

FIG. 6 discloses steps in the unit forecast creation analysis.

FIG. 7 is a diagram illustrating report creation features.

FIG. 8 illustrates some of the simulation options provided by certain embodiments.

FIG. 9 is a diagram illustrating predictive drivers for price forecasting.

FIG. 10 discloses the steps in the area of Data Transformation to generate price forecasts.

FIG. 11 illustrates the steps used to analyze input data to create accurate near-term pricing forecasts.

FIG. 12 lists the predictive drivers to accurately forecast tactical, near-term inventory.

FIG. 13 describes the steps in the area of Data Transformation to generate inventory forecasts.

FIG. 14 discusses the analysis steps in creating an inventory forecast.

FIG. 15 is a diagram that further illustrates exemplary details of the steps in data transformation process.

FIG. 16 is a diagram that illustrates exemplary details in the steps for analyzing the transformed data to create a forecast.

FIG. 17 illustrates the components of a generic computing system connected to a general purpose electronic network.

### DETAILED DESCRIPTION OF THE PREFERRED EMBODIMENTS

In certain embodiments, there are three primary driving factors to simultaneously increase sales, and reduce inventory:
a. accurate demand forecasts
b. fine-tuned inventory allocation
c. rapid replenishment or service processes—both from suppliers/contractors/partners, as well as from internal company sources.

The certain embodiments, present invention provides a. accurate demand forecasts, and b. fine-tuned inventory allocation, and influences c. rapid replenishment, by reducing the ordering of unnecessary products and services.

Accurate forecasts, or lack thereof, are the Achilles Heel of many a company or organization. Because a company has inaccurate forecasts (or sometimes no forecasts), it has insufficient or the wrong type of staff, product, and other fulfillment mechanisms available when the customer demand is received. Or such products and/or staff are at the wrong places—wrong branch office, store, plant, and warehouse. Consequently, the customer demand does not translate into an order, or the order gets cancelled, or eventually customer business diminishes, as customers defect to more responsive, competing providers. If a company had accurate forecasts, then the right staff or product could be available at the right staff at the right place, at the right time. Every percent increase in forecast accuracy can improve sales level by quarter to half a percent. It will also reduce inventory by one to two percent, on an average. In certain embodiments the present invention creates very accurate forecasts, as we shall see later in this Provisional Patent Application.

Fine-tuned inventory policies: accurate forecasts are highly useful, and their effectiveness is augmented by inventory policies. Traditionally, inventory policies determine the timing of orders on supply, the size of the order, and the location to deliver the order to. However, depending on the supply (‘supply’ used generically, since the present invention applies equally well to service organizations, as well as product organizations) lead-time, order costs, etc, some tradeoffs are made to hold extra inventory to satisfy the demand during (supply) lead-time. The trade-offs lead to more-than-necessary inventory. The present invention reduces such tradeoffs, by directly coupling the accurate demand forecasts in real time to the supply side.

Rapid replenishment: replenishment time—whether it be from internal company sources such as manufacturing plant, branch office—or from external sources such as contractors, suppliers—consists of a) the time taken by company to determine the order quantity, service/parts/products to be ordered, b) the time to process and place the order, c) time to expedite the order (not applied to every single order), and d) the time is takes for the source to fulfill the order. In certain embodiments the present invention reduces a, c, and d) times indirectly-leading to a reduction in replenishment lead time, further increasing sales, and reducing inventory. a) is reduced because increase in forecast accuracy increased the company's confidence in the forecasts, and they spend less time in second-guessing the forecasts; c) is reduced since fewer orders have to be expedited, and d) is reduced since the supplier has to change/redo the schedule/quantity on fewer orders.

The Current State of Forecasting

Current commercially available forecasting products use statistical techniques, or collaborative/iterative processes to compute forecasts. Consequently, the forecasts are not very accurate, leading to all the problems in inaccuracy. The three main types of demand forecasting are as follows:

Statistical Forecasting

This is the most commonly used technique today. A variety of statistical methods are available—including ARIMA, Exponential Smoothing—etc. These methods basically share several elements:
1. Their core assumption is that history repeats itself. These methods all extrapolate history.
2. One has to ‘seed’ the analysis; if the human-chosen seed is bad, then forecasts are even more inaccurate.
3. The method does not ‘learn on the fly’ as field parameters (market conditions, internal process time, etc.) change. These algorithms continue to blindly apply the batch-learned rules, even if the underlying market dynamics have rendered the relationships inaccurate.
4. They all operate with limited number of input variables—usually 1-2. While theoretically, more variables can be used, no methods have been developed to process them reliably into an accurate forecast.
5. Input data are all backward looking such as historical orders—etc.
6. Environmental variables—gross state of the economy, customer's economic conditions, weather, etc. are not taken into account. The methods are also incapable of systematically accounting for and precisely processing such data.
7. cross-elasticity: cross-elasticity among demand for company's own products, with competitors' products, cannot be factored in easily, wasting such important contextual variables.
8. forecasts outputs are created at usually a product/service line level-historical proportions are then used apportion the forecast by specific product/SKUs/services.
9. Forecast outputs are created directly in macro time buckets such as months. Historical proportions are then used to divide the macro forecasts into smaller time buckets such as weeks. Usually, such techniques are so inaccurate at even a weekly level, that they are not used for smaller time increments such as days, hours or minutes.
   Collaborative Forecasting

Collaborative techniques (CT) get forecast projections from business partners, and iteratively work out the discrepancies among the various partners' forecast projections—by working out a compromise iteratively and manually. Such techniques have various shortcomings, some of which are:
1. the partners' forecasts are many times aspirational, and include guesswork. Many partners inflate forecasts, so they can get a larger allotment of inventory. Some are just not trained to forecasts, and hence do so quite inaccurately. CT treat all such forecasts, with same weight, since they have not data-based or analytical means of distinguishing between bad and good forecasts, or good/bad data.
2. the techniques do not have strong analytical underpinnings: ‘collaborative’ techniques are iterative and manual, with little rigorous analysis. Multiple inaccurate, aspirational forecasts collaborated-on manually do not necessarily create an accurate forecast. And the output quality reflects that.
   Event Management and Activity Monitoring

These techniques monitor ‘events’ get current data; look for exceptions, and alert appropriate people when a pre-determined out-of-bound condition occurs. These techniques are not true forecasting techniques, and
1. The output is not a true demand forecast, but at best an input of a singular, point conditions
2. There is very little, or virtually no analysis; and multiple inputs are not analyzed simultaneously in a combined fashion
3. the objective is to alert, and let the managers work out a solution to the out-of-bound condition, rather than giving them a pre-processed output in the form of a demand forecast.
   Neural Networks/Artificial Intelligence

There are several neural network/artificial intelligence techniques available—and some may have even attempted to forecast demand. However, these techniques have met with very little success.
1. The techniques were developed for, and used with, historical, batch data such as the data used in statistical methods listed above. Consequently the techniques were of limited use in creating accurate forecasts.
2. the types of input data used are singular in nature, such as orders on the company, etc. i.e. multiple, forward looking data streams are not used

In certain embodiments, the present invention provides several techniques and methods which create an accurate forecast:

Their core assumption is that the present determines the future. These methods interpolate the future, and extrapolate the present conditions to create an accurate forecast.

‘Seeding’ of the analysis in not required; these methods learn by itself how this works.

In certain embodiments, the present invention method is adaptive, i.e. ‘learns on the fly’ with every iteration, as field parameters (market conditions, internal process time, etc.) change. So, as the underlying market dynamics change the relationships between inputs and outputs, the algorithms provided adapt automatically.

In certain embodiments, the present inventive algorithms or techniques can operate with a large—and essentially unlimited, for all practical purposes—number of input variables, if necessary.

Input data are all forward looking i.e. futuristic—i.e. inventory in stores/channels, customers' financial condition, weather forecasts, stores' orders on distribution centers—etc.

Environmental variables—gross state of the economy, customer's economic conditions, weather, etc. can be taken into account. The provided methods are also capable of systematically accounting for and precisely processing such data. These data can also be combined with current ‘direct’ data such as inventory, etc.

Cross-elasticity: cross-elasticity among demand for company's own products, with competitors' products, can be factored in easily, utilizing value of these important contextual variables.

Forecast outputs may be created directly at specific SKU/Model/Service number level.

Forecast outputs are created directly in macro or micro time buckets—such as week, day, or even an hour. Forecasts can go down to minute or second, if necessary.

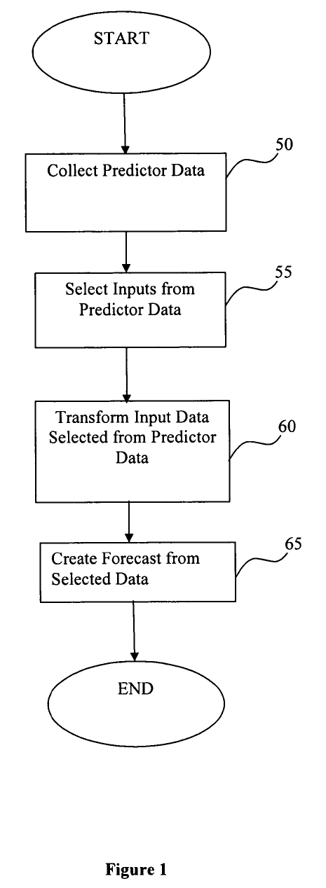

FIG. 1 illustrates the basic steps for short term forecasting in certain embodiments of the present invention. In certain embodiments, each of the boxes represent computing modules (whether on one processor or distributed on a network of processors) while the lines represent data connections (for example, through a network) between the computing modules. FIG. 1 is exemplary only and those skilled in the art would recognize various modifications and alternatives, all of which are considered a part of the present invention. In step 50, the predictor data that may be used in the short term forecast is identified and/or collected. In step 55, the inputs into a forecasting model are selected from among the predictor data identified and/or collected in step 50. In step 60, the selected input data is transformed in a manner that they may be effectively used by the forecasting model. Finally, in step 65, the forecasting model creates the short term forecast based on the transformed input data and the forecasting rules embodied in the forecasting model. Each of these steps are discussed in greater detail next. It should be understood that, in certain aspects, the present invention provides unique features in each of these steps discussed above whereas the actual implementation of the forecasting model using the unique features discussed herein is within in the abilities of one skilled in the art of developing and implementing automated or semi-automated forecasting models.

In step 50, which relates to identifying and collecting the data related to the forecast of a particular good or service (for example, forecast of a commodity price or volume, forecast of a demand for a product, or a forecast of a contact center volume) the following activities are performed: (a) driver data identification and (b) data tagging as discussed next.

(a) Driver Data Identification

In contrast to existing forecasting techniques and algorithms, certain embodiments of the present invention provides for the use of ‘driver data’ inputs to generate forecasts. The underlying assumptions—which have now been validated by real-life industry applications—are: (i) future is determined by the present drivers, and (ii) these drivers are observable and measurable.

The demand drivers that are identified and used by certain embodiments of the present invention are determined based on the specifics of a particular forecast but are all based on the following categories of investigation.

Demand drivers: factors which directly influence demand quantity and/or timing are identified. For example, level of existing customer inquiries about product availability would be a driver of future customer orders for the same items they inquired about. Also, customers' financial health, their psychological state/makeup may be used as factors. For commodity pricing forecast, the commodity production data may be an input while for. The number of customers that have signed up for a particular service may be a demand driver for a customer service center that provides the particular service. Typically, 10-200 of such independent drivers may be collected for each forecast.

Supply drivers: these are factors which would directly influence supply quantity or timing. For example, oil exploration and extraction levels in the middle east countries would be a supply driver of the amount of oil imported into the US. Likewise, production data of agricultural products would be a supply driver of commodities that are directly based on the agricultural products. Factors about suppliers' financial condition, if available, could also be used as a supply driver, for example, if one of the suppliers is likely to go out of business or severely curtail supply.

Competitive drivers: these are factors affected by actions of competitors which would influence either the demand or supply. For example, in the case of sales forecasting, competitor's pricing moves in the public domain, can be collected and used as a factor. Also, to forecast sales, the presence of competitor in a new bid would be factored in.

Environmental drivers: several environmental drivers directly influence an entity being forecast. Examples of environmental variables are: General financial market conditions (since a depressed financial market may drive more money into a commodity exchange while a booming financial market may reduce the money flow into a commodity exchange); weather—including hurricanes, precipitation, temperature; or customer confidence and economic activity indices.

Example of predictor data (or drivers in the categories above) that may be used for forecasting commodity pricing, for example, for forecasting price of a specific grade of crude oil in US would include:
Demand drivers: short term weather forecast, passenger air miles booked, consumer unemployment, housing starts, manufacturing open orders, manufactured goods inventory;
Supply Drivers: crude oil extracted in Saudi Arabia, interest rate in China, oil imports into China, hurricanes over oil shipping lanes, crude oil imports, crude oil inventories in US, refinery inputs in Europe;
Competitive Drivers: price of European Brent crude, supply of coal, price of coal; and
Environmental drivers: long term weather forecast, consumer confidence, major worldwide stock market performance.

(b) Data Tagging

In certain embodiments, the present invention provides the use of “meaningful” data tagging scheme to identify the data types. These unique data tagging techniques involves tagging raw data. The data tags determine the pre-processing, validation, input selection and eventual forecast generation. For example, certain data tags may specify the date of availability of certain data while certain other data tags may specify what kind of processing may be performed on the data (for example, whether the data can be aggregated.

In step 55, the predictor data identified and/or collected is screened so that input data to the forecast model is selected and the selected data is then transformed in the step 60. The process of selecting and transforming the input data in steps 55 and 60 is discussed in the following sections.

Data Preprocessing and Presentation to Model

Some of the unique ways of processing input data enable extraction of maximum forecast accuracy from the available input set. The unique techniques developed provided by certain embodiments of the present invention in the area of data pre-processing and presentation to model include:

Inter-variable processing: variables which have a combined effect on the forecast are pre-proportioned—either subtracted or added to another, or another ratio is taken so that the combined effect is best captured. This is in contrast to conventional pre-processing where each variable in preprocessed by itself. For example, inventory-type data variables may be added to each other to create a consolidated input, for example, in the case of crude oil entry from different ports of entry the data from the different ports of entry may be combined if the particular port of entry does not materially impact the item being forecasted (a price of oil). Another example is that input variables which have differential impact on the forecast entity are subtracted from each other. For example, in forecasting the price of Arab crude oil in relation to West Texas Intermediate crude oil the FOB price inputs are subtracted from each other in order to anchor the Arab crude oil data to a more stable index value (based on the West Texas Intermediate crude oil).

Asynchronous input presentation: this technique involves the selective advancing or deferring input presentation, in relation to the time the inputs are generally available. If some of the inputs variables are known in advance—for example, holidays—they are time advanced—i.e. presented several weeks before, at the time of forecast creation. This way, the known impact of holidays can be learned in a systematic way. This is in contrast to current techniques where all inputs are synchronously presented—i.e. if inputs available at one time are presented at the same time.

Relative gradient inputs: for example, if forecast for 4th week is be created, current drivers' relative gradient from 1 st to 4th week is presented, rather than the unprocessed inputs. The relative gradient indicates not only the actual forecast value for the fourth week but also indicates the trend line which fits that value (i.e., it may indicate whether the value is increasing or decreasing or its positioned on a plateau).

Stretching and scaling: all the inputs are scaled and stretched in proportion of true range. In certain embodiments, each input is then divided by its mean value to normalize.

Cross-normalization: In certain embodiments, each input is then divided by the means of all means and cross-normalized, so that the cross-normalized variables all have the same mean.

Non-zero values: zero values in the input data set deteriorate the forecasting accuracy. Hence zero values have to be changed, for example, to either a small positive or negative number (enough to maintain sensitivity, but not so high that these numbers converted from zero determine the forecast).

Input Selection

Inputs have to be selected from the available inputs and the pre-processed inputs to present to the forecasting engine. In certain embodiments, the present invention provides techniques and algorithms to select inputs such that: (1) the inputs with the maximum impact on forecast accuracy are selected, but (2) the total number of inputs used is contained.

Taken together, these techniques involve a unique methodology for input selection. Conventional techniques involve using genetic algorithms to select inputs. The problem with conventional algorithms is that it is a trial and error method, and one is never really certain whether the best inputs have been selected.

In certain embodiments, the present invention provides techniques that involve two crucial steps: (1) Sensitivity: as a first step, the sensitivity of the forecast to the individual inputs is determined. Sensitivity refers to the impact on the forecast of caused by a change in a value of the input. Inputs are arranged in descending order of sensitivity (or some other order or grouping based on the sensitivity). (2) Correlation-based elimination: variables which are highly correlated with the sensitive inputs, are eliminated and reduced. The correlation ‘threshold’ is set to optimize the performance of the forecast. One of the goals is to use the smallest number of variables that significantly influence the forecast. For example, in certain embodiments in which several thousand raw data variables have been identified, the target may be to reduce the input variables to 150-200 or so.

Algorithm or Technique Selection

Conventional forecasting techniques require considerable amount of data to draw inferences about forecasts. In certain embodiments, the techniques provided by the present invention can make do with half to a fifth of the data required by conventional techniques.

The core value is accomplished based on using more lateral/simultaneous data inputs, and not as much longitudinal/time-series data. This assumes that the forecast can be more effectively made based on data and variables that are available in the forecast window rather than looking at time-series or historical data. That is, a four week forecast may be done using data that is available over a four week period prior to the current date (on which the forecast is made) and this window could be updated as the current date moves forward. Conventional techniques rely mostly on the longitudinal/time-series data. Since lateral data push the boundaries of conventional mathematics, it is essential to zero-in on the exact forecast value with minimally available data. The unique technology developed relies on tapping input variables selectively, to achieve maximum forecast accuracy as discussed next.

Gradient tapping: the technique developed involves selectively tapping relative gradient inputs. The higher the relative gradient, the higher the number of periods' of data used for that input.

Inputs to tap: the first step involves selecting the inputs which should be tapped at all. The inputs are selectively and individually tapped. The selection of inputs to tap is done automatically by the application. It is based, in certain embodiments, on rate of change in input value for the immediate past periods, and the standard deviation of the value. A gradient is calculated=(rate of change)×(standard deviation). Inputs are rank-ordered based on the value of the gradient. The application automatically selects the inputs which would add up to, for example, 40% of the cumulative gradient value. Each inputs which fall in that bracket is tapped.

Tap length: once having decided which inputs to tap, the next step is to decide the tap length for those selected inputs. Tap length is set based on gradient value. Higher the value, longer the tap length, with the maximum tap length equal to the number of periods ahead for which forecast is being created (for example, if forecast is for sixth period ahead, then the maximum tap length will be six). All other tap lengths are proportionately adjusted automatically.

As part of generating the forecast in step 65, certain embodiments of the present invention provide for parameter optimization and multi-period forecast bridging which are discussed in the following sections. It should be noted that the features discussed below relate to novel parts of certain embodiments of the present invention which relate to the particular identification of predictor inputs, their selection, and transformation before being used in a forecast model. Details of forecasting models that may be used with the features of the present invention are well known to those skilled in the art. For example, such forecasting models or techniques are discussed in a wide variety of literature including: Chapter 8 on Advanced Forecasting Models in book Forecasting Methods and Applications by Steven Wheelright & Rob Hyndman; Published by John Wiley & Sons; Neural Networks: A Comprehensive Foundation by Simon Haykin; 2nd Edition; Neural Networks for Pattern Recognition by Christopher Bishop; Oxford University Press; or Object-Oriented Neural Networks by Joey Rogers; Academic Press, the disclosures of which are incorporated by reference herein in their entireties.

Parameter Optimization

In certain embodiments, the present invention quickly zeroes in on the best parameters to use in forecast calculation based on the features discussed below. Taken together, these techniques enhance forecast accuracy.

Parameter-variation: vary feedback-based forecasting algorithms' parameters rapidly. Use error threshold such that the training sample error size is reduced to a minimum.

Training-based optimization: since the data obtained is limited, the entire data obtained is used for training the model and no cross-validation is performed using the data. In conventional models that use time-series data, often a percentage of the data is not used for training and is used instead for testing and cross-validation. However, in certain embodiments of the current invention, the most effective forecasts are derived by using all the data for training the model (which may, for example, be a neural network implementation that would be within the abilities of one skilled in the art).

Relative gradient-based weights file: inputs are initial-weighted in proportion to their respective relative gradient, as described below.

Correlation: first, correlation is calculated for between each input variable, and the forecast entity for the immediate past periods.

Correlated Gradient: is calculated by multiplying the Gradient (as discussed earlier herein) by the correlation calculated.

Relative gradient: is calculated by dividing the Correlated Gradient for an input by the average of Correlated Gradients of all the inputs.

Weights file: a file is automatically created with the Relative Gradients of each input, which is then automatically used as an initial weights file.

Period data weighting: latest periods of data are given higher weights, so that they influence the forecast more than older periods.

Multi-Period Forecast Bridging

In short term forecast, for example, for a 0-16 weeks forecast, certain embodiments of the present invention cross-applies forecast values. In conventional techniques, shorter term forecasts are typically fed as inputs to longer term forecasts. However, in certain embodiments, the inventors have discovered that quite the opposite is true when creating accurate short term forecasts. Longer term forecasts (say a 12 week) are fed as inputs to shorter term forecast (say, 6th week forecast). This improves forecast accuracy. However, if the longer term forecasts are fed as inputs directly to shorter term forecasts, it is not sufficient. One has to create a ‘relative gradient input’ from the longer term forecast, and only then feed it as input to the shorter term forecast.

In certain embodiments, the longer term forecast needs to be aggregated before being fed in to the short term forecast. Therefore, a twelve week forecast may have the last 4 week aggregated into a monthly forecast and the aggregate monthly forecast may be an input to the shorter term (for example, 4 week forecast). This aggregation of the longer periods of the long term period to provide an aggregate input based thereon to the short term forecast further improves the accuracy of the short term forecast.

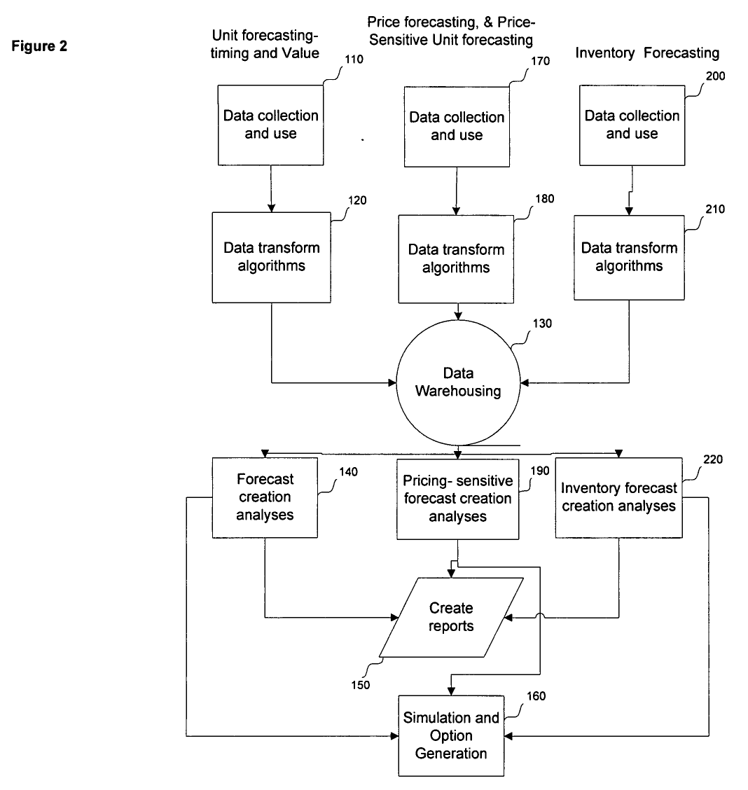

Certain specific embodiments of the present invention are discussed next with respect to FIGS. 2-16.

One of the features is short term tactical forecasting, based on near-real-time predictive drivers. The method combines interpolation from the future, and extrapolation based on near-real-time predictive drivers. Some of the features are with reference to FIG. 2 (in which three embodiments are disclosed with respect to forecasting unit timing and value, price and price sensitive unit forecasting, and inventory forecasting, respectively).
Data collection and use (areas 110,170,200): use of tactical predictive indicators;
Data transformation algorithms (120,180,210): means of ‘conditioning’ the data to account for practical difficulties in obtaining complete, accurate field data;
Load/Warehouse (data)(130): the data loading and warehousing techniques which make the forecast possible;
Analysis (140, 190, 220): analysis to create short term forecasts;
Report creation (150): exception-based report creation that ‘dynamically’ adjusts to the current items most in need of attention; and
‘What-if’ simulation (160): scenario creation and testing.

In the next section, each of the above areas will be addressed separately for (1) unit forecasting, (2) pricing forecasting, and (3) inventory forecasting. It should be noted that, in certain embodiments, each of the blocks in FIG. 2 could represent one or more computing modules on one or more computing system and one or more of lines represent data or network connections between the computing modules.

Unit Forecasting

End objective here is to forecast the timing and the number of units which will be needed/demanded/sold. The timing (for example. the timing of arrival of a container into a port) could be forecast independent of the magnitude (for example, of the ‘security risk’) posed by a container can be forecast independent of its timing of arrival into the port. More often than not, this technique is used to forecast discrete units of demand, sales, supply, manufacturing output, service calls required, etc.

110. Data Collection and Use

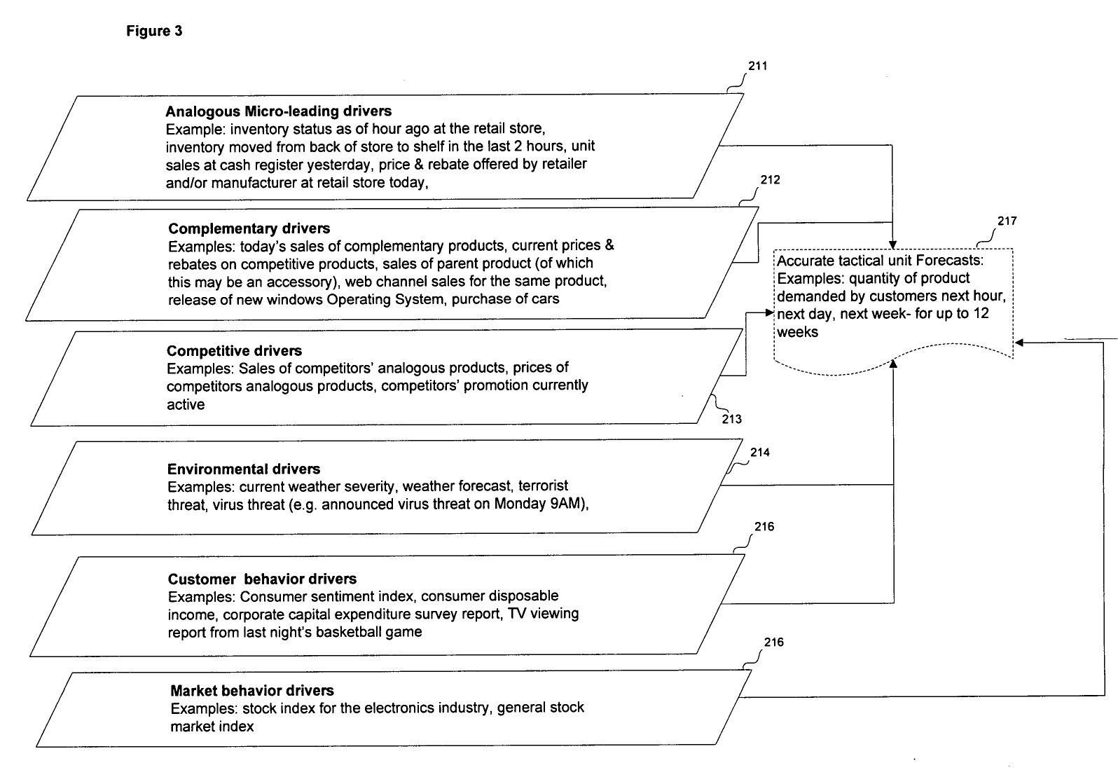

In the area of Data Collection and Use (element 110), some of the features include having successfully collected and used the following types of data to accurately forecast tactical, near-term behavior as shown in FIG. 3 (it should be understood that FIG. 3 is exemplary only and those skilled in the art would recognize various alternatives and modifications all of which are considered to be a part of the present invention).

Analogous micro-leading drivers 211 include drivers such as POS sales, shipments, forecasts provided by channel partners, etc.

Complementary drivers 212 include product lines, service lines, process elements have complementary demand drivers—i.e. when certain inputs go down, the forecast entity goes up.

Competitive drivers 213 are based on a relationship between sales of competing products, competing resources, and competing process elements. Use of competing drivers enhances the forecast accuracy.

Environmental drivers 214 include weather, pollution, traffic, etc. which are drivers of the forecast entity

Customer behavior drivers 215 include customers' current income, profitability, business level, investment propensity, customer surveys, etc. that are predictors and drivers of the customer's propensity to purchase, and therefore demand

Market behavior drivers 216 include market behavior such as stock market indices, etc. which are surrogates for the prevailing ‘market’ conditions, and drivers of the unit forecast. All of these drivers are used to in the next step 217 of creating the short term forecast.

120. Data Transformation

Frequently, above-mentioned data are not available in clean, complete formats. And the available data have to be ‘conditioned’, and the conditioning has to be done precisely, so that it comes close to the real-data, as if it were to have been available, and the forecast generated is not distorted.

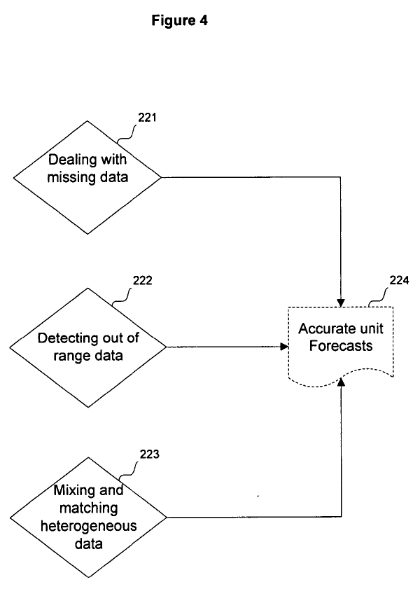

FIG. 4 discloses the following features in the area of Data Transformation to generate unit forecasts.

Dealing with missing data 221 includes techniques and algorithms to ‘fill-in’ for missing data, or make a determination of the forecast influence based on current data

Detecting out of range data 222 includes techniques to detect data, which are ‘out of range’, based on current/dynamic conditions which are typically not static, predetermined rules.

Mixing and matching heterogeneous data 223 relates to techniques to use data of different units, of different time buckets, pertaining to different forecast entities, etc. The transformed data is used in the next step 224 of creating the unit forecast.

130. Data Loading/Warehousing

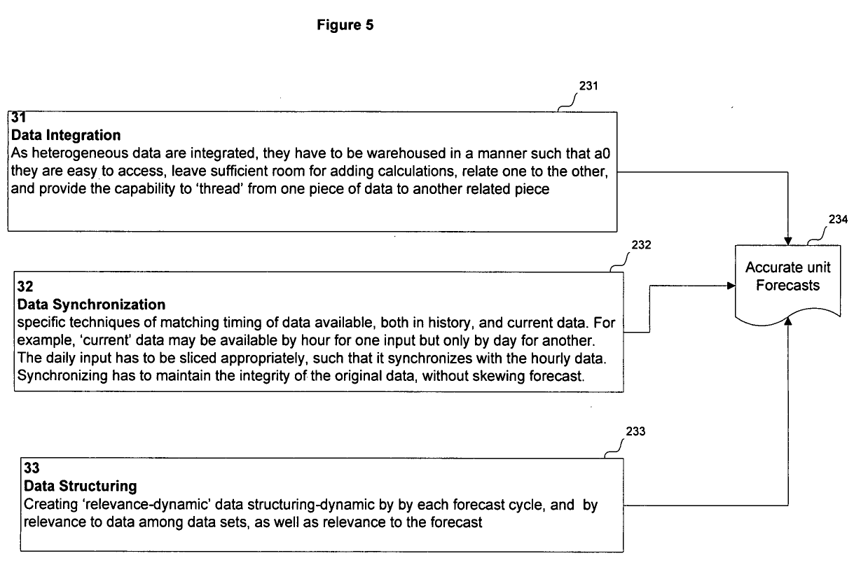

As the heterogeneous input data are used to create accurate, near term forecasts, a high premium is placed on how data are stored and integrated in the data warehouse. In certain embodiments, the following features in the area of Data Warehousing as shown in FIG. 5.

Data Integration 231 illustrates that structured and unstructured data are integrated in unique ways to create accurate forecasts.

Data synchronization 232 illustrates that data from different time increments (e.g. minutes, days, weeks) covering the same period (e.g. day of Mar. 1, 2004) have to be synchronized to be analyzed. Likewise, data of different time periods (e.g. day of Mar. 1, and Mar. 15, 2004) have to be synchronized.

Data structuring 233 illustrates that data is structured in the data warehouse so as to enable real-time analysis of history data & forecasts, and ‘real-time’ context-sensitive navigation. The data in the forecast is then available in the next step 234 of the forecast creation process.

140. Forecast Creation Analyses

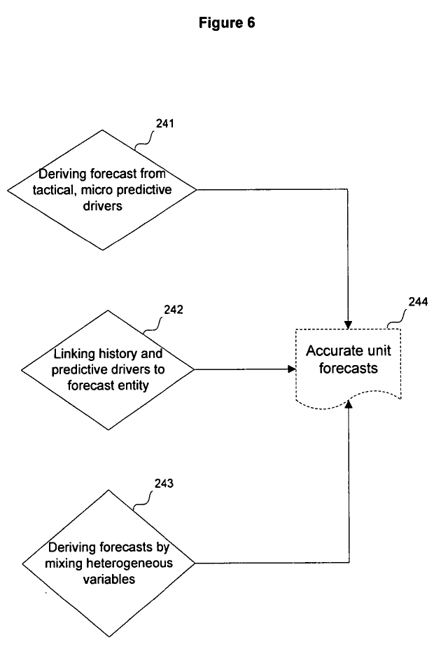

Input data have to analyzed to create accurate near-term unit forecasts. As disclosed in FIG. 6, the forecast creation analysis includes the following steps:
Deriving forecasts from tactical, micro predictive drivers 241 uses algorithms and techniques to derive forecasts from micro, predictive drivers, and leading indicators;
Linking history and predictive drivers to forecast entity 242 uses available historical data to link history to the predictive/leading drivers, so that both history and the predictive/leading drivers can be utilized create forecasts in step 244;
Deriving forecasts by mixing heterogeneous variables 243 refers to the task of mixing heterogeneous input data in the process of creating the unit forecast in step 244.
   150. Create Reports

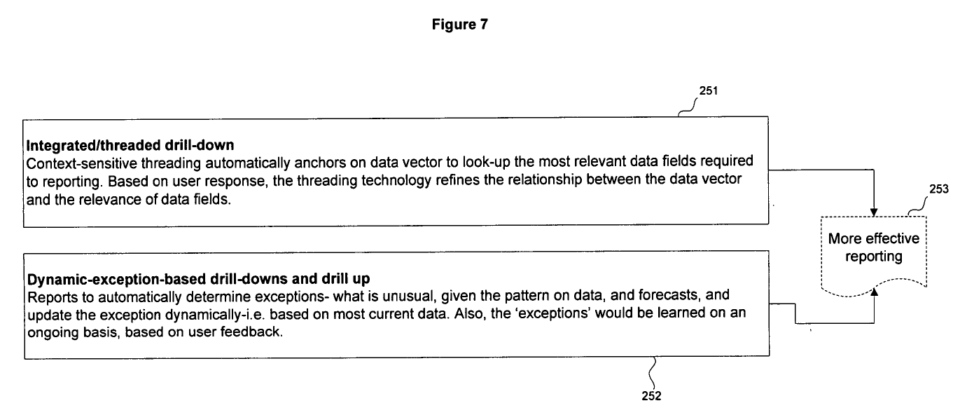

Accurate and relevant reporting can enhance or limit the effectiveness of good, tactical forecasts in managerial decision-making. Some of the features of report creation are disclosed in FIG. 7.

Threaded, integrated drill-downs 251 illustrate ways to ‘thread’ the data, and connect data to specific forecast entities. The technique makes real-time determinations to link and thread the most appropriate data to the forecast, and data among itself, so that the most appropriate data are linked together for a user of the forecast.

Dynamic-relevance-based drill downs and drill ups 252 provides the most relevant data supporting a forecast by providing drill-down/up to the most relevant data to facilitate analysis by a user of the forecast.

160. Simulation and Option Generation

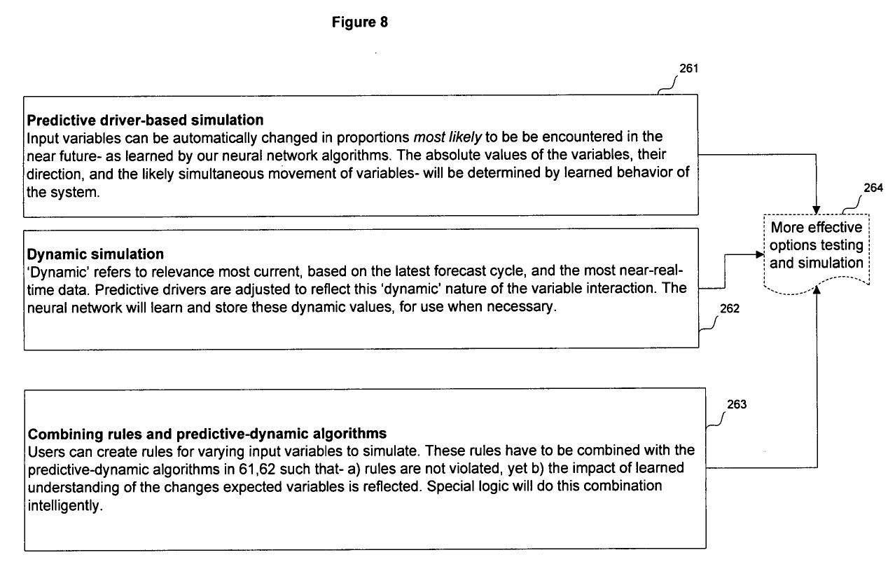

Decision-makers would like to know ‘what-if’ scenarios, the impact of various scenarios, of changing input conditions, and varying them dynamically to test various alternatives. FIG. 8 illustrates some of the simulation options provided by certain embodiments.

Predictive driver-based simulation 261 includes techniques to simulate the outcomes (forecasts) based on varying predictive drivers and leading indicators.

Dynamic relevance-based simulation 262 includes techniques to generate options and simulate outcomes, based on current/dynamic relevance of the predictive/leading indicators.

Combining rules and NRT algorithms 263 includes techniques to combine pre-determined policies/rules with near-real-time algorithms to simulate outcomes. Outputs from these techniques may be input to another process 264 which allows for further simulations that are coordinated with (or receive input from) earlier simulations.

Pricing Forecasting

End objectives here are to forecast a) the timing and the number of units which will be needed/demanded/sold—based on price, and b) the price at which items would be available for purchase or sale. More often than not, this technique will be used to forecast discrete units of demand, sales, supply, manufacturing output, service calls required, etc. The pricing forecasting process is also discussed next with respect to the areas of data collection and use, the data transformation, and the forecast creation and analysis.

170. Data Collection and Use

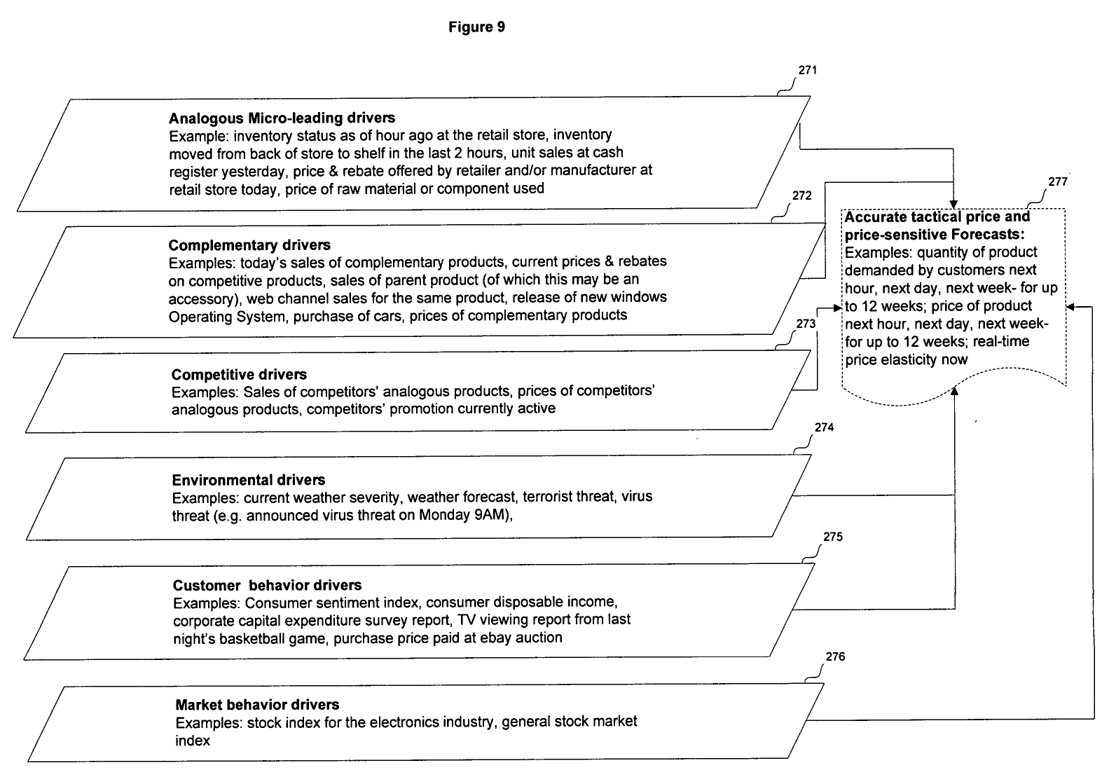

In the area of Data Collection and Use 170, features include successfully collecting and used the following types of data to accurately forecast tactical, near-term prices, and price-based unit forecasts as shown in FIG. 9.

Analogous micro-leading/predictive drivers 271 include drivers such as POS sales, promotions, price forecasts provided by channel partners, etc.

Complementary drivers 272 include product lines, service lines, process elements have complementary price-elasticity drivers—i.e. when certain inputs (or drivers) go down, the forecast entity goes up.

Competitive drivers 273 are based on relationships between sales & prices of competing products, competing resources, and competing process elements. Use of competing drivers enhances the price-forecast accuracy.

Environmental drivers 274 include weather, pollution, traffic, etc. that influence the price of the forecast entity either directly or indirectly.

Customer behavior drivers 275 include customers' current income, profitability, business level, investment propensity, customer surveys, etc. that are predictors and drivers of the customer's propensity to purchase, and pay a specific price for an item

Market behavior drivers 276 include market behaviors such as stock prices, consumer price index, consumer disposable income, etc. that are surrogates for the prevailing ‘market’ conditions, and influence the price forecast. For examples, higher stock prices might reduce the money that is available to be spent in a commodity exchange and may therefore influence a lower price for a commodity. These drivers are then input to the next stage 277 of the price forecast process.

180. Data Transformation

Frequently, above-mentioned data are not available in clean, complete formats. And the available data have to be ‘conditioned’, and the conditioning has to be done precisely, so that it comes close to the real-data, as if it were to have been available, and the pricing forecast generated is not distorted.

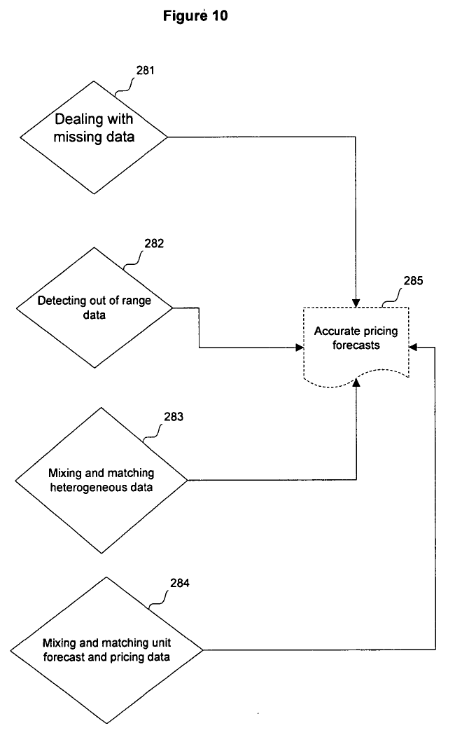

FIG. 10 discloses the steps in the area of Data Transformation to generate price forecasts.

Dealing with missing data 281 includes techniques and algorithms to ‘fill-in’ for missing pricing data, or make a determination of forecast ability based on current data.

Detecting out of range data 282 includes techniques to detect pricing data, which are ‘out of range’, based on current/dynamic conditions which are these are not static or based only on predetermined rules.

Mixing and matching heterogeneous data 283 includes techniques to use data of different units, of different time buckets, pertaining to different forecast entities, etc.

Mixing and matching of forecast and pricing data 284 includes factoring in the price elasticity of demand or of some of the other factors that are used as an input to the forecast model.

190. Unit Forecast Creation Analyses

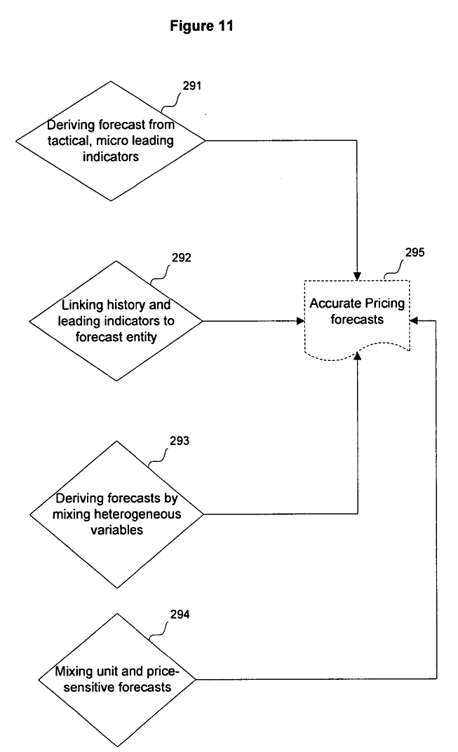

As shown in FIG. 11, input data is analyzed to create accurate near-term pricing forecasts using the following steps.

Deriving forecasts from tactical, micro predictive drivers 291 includes algorithms and techniques to derive pricing forecasts from micro, predictive drivers, and leading indicators.

Linking history and predictive drivers to forecast entity 292 includes utilizing available historical data to link history to the predictive/leading drivers, so that both history and the predictive/leading drivers can be utilized create pricing forecasts

Deriving forecasts by mixing heterogeneous variables 293 includes to mix heterogeneous input data (for example by normalization and/or cross normalization).

Mixing unit and price-sensitive forecast 294 factors in the fact that: unit forecasts are sensitive to pricing, and price elasticity. Therefore, this elasticity is factored in for tactical near-term pricing-unit forecast integration.

Inventory Forecasting

End objectives here are to forecast a) the timing and the number of units which will be needed/demanded/sold—based on inventory, and b) the inventory which will result from normal business activity. Inventory could be of physical assets, or entities such as customer orders, human capital, financial capital, etc. Features relating to the forecast are discussed next with respect to data collection and use 200, data transformation 210, and the forecast analysis creation 220.

200. Data Collection and Use

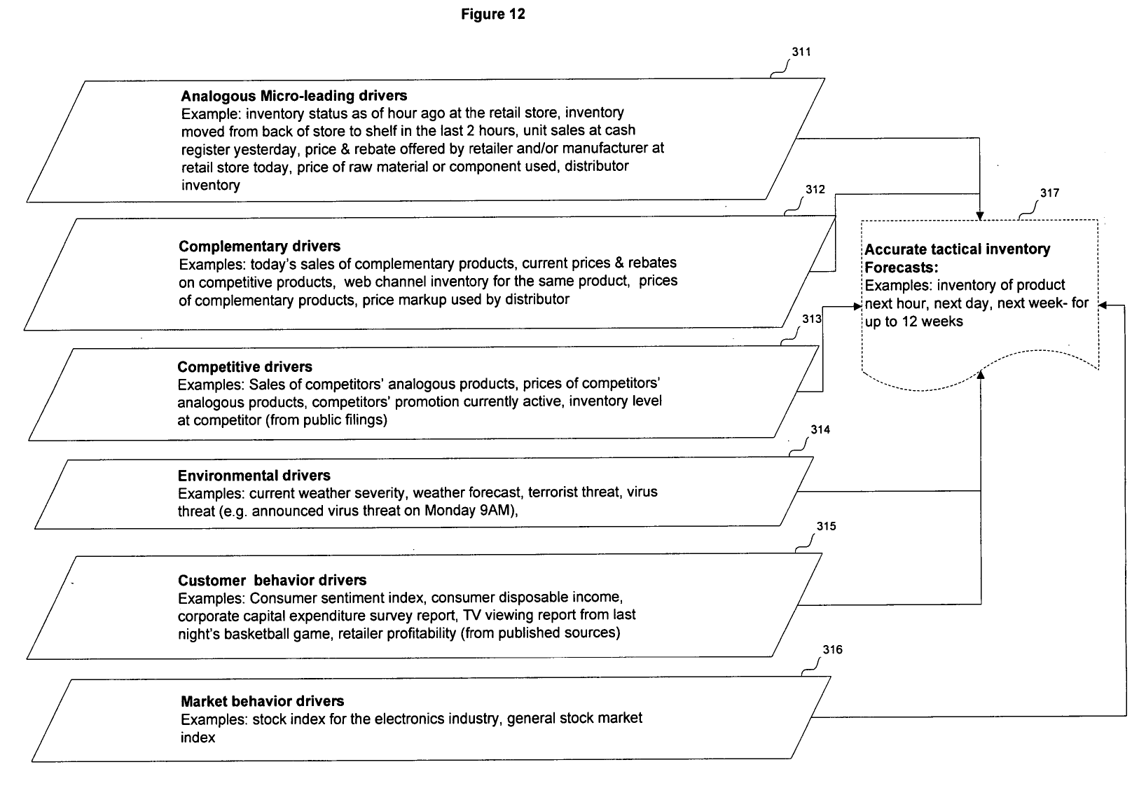

In the area of Data Collection and Use 200, FIG. 12 lists the predictive drivers to accurately forecast tactical, near-term inventory, and inventory-based unit forecasts

Analogous micro-leading/predictive drivers 311 include use of drivers such as POS sales, on-shelf inventory, warehouse inventory, RFID data, real-time order backlog inventory, etc.

Complementary drivers 312 include product lines, service lines, process elements have complementary inventory-elasticity drivers—i.e. when certain inputs go down, the forecast entity goes up.

Competitive drivers 313 are based on relationship between sales & inventory of competing products, competing resources, and competing process elements. Use of competing drivers enhances the inventory-forecast accuracy.

Environmental drivers 314 include weather, pollution, traffic, etc. that influence the forecast inventory.

Customer behavior drivers 315 includes customers' current inventory, financial health, etc. that are drivers of the customer's propensity to purchase and hold inventory.

Market behavior drivers 316 includes: market behavior such as stock prices, consumer price index, consumer disposable income, etc. that are surrogates for the prevailing ‘market’ conditions that influence the inventory forecast.

210. Data Transformation

Frequently, above-mentioned data are not available in clean, complete formats. And the available data have to be ‘conditioned’, and the conditioning has to be done precisely, so that it comes close to the real-data, as if it were to have been available, and the pricing forecast generated is not distorted.

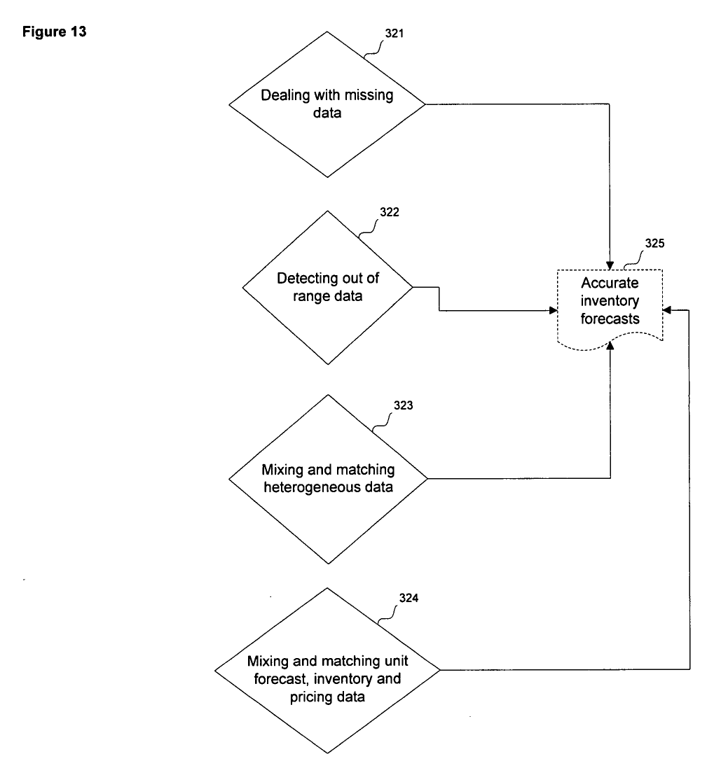

FIG. 13 describes the steps in the area of Data Transformation to generate inventory forecasts.

Dealing with missing data 321 includes techniques and algorithms to ‘fill-in’ for missing inventory data, or make a determination of forecast ability based on current data.

Detecting out of range data 322 includes techniques to detect inventory data, which are ‘out of range’, based on current/dynamic conditions.

Mixing and matching heterogeneous data 323 includes specific techniques to use data of different units, of different time buckets, pertaining to different forecast entities, etc.

Mixing inventory, pricing and unit forecasts 324 dynamically link pricing, unit sales/demand and inventory. Dynamic cross-elasticity is calculated using known techniques. The output from the data transformation is provided to the next stage 325 in the inventory forecast creation process.

220. Inventory Forecast Creation Analyses

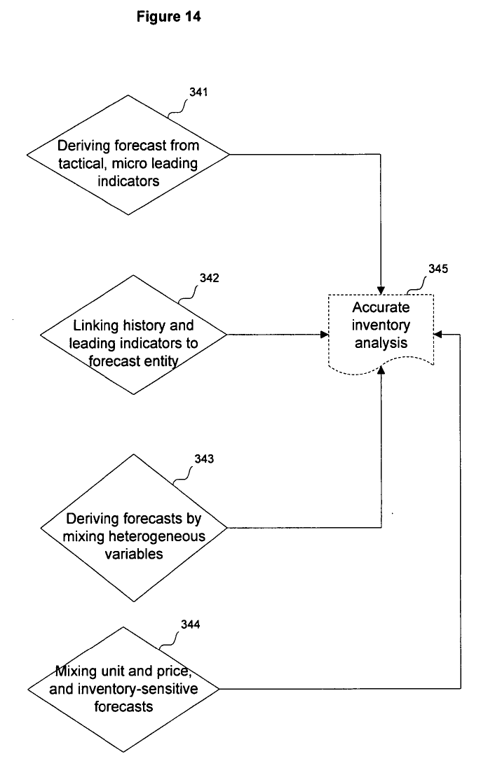

Input data is analyzed to create accurate near-term pricing forecasts. FIG. 14 discusses the analysis steps in creating an inventory forecast.

Deriving forecasts from tactical, micro predictive drivers 341 includes algorithms and techniques to derive inventory forecasts from micro, predictive drivers, and leading indicators.

Linking history and predictive drivers to forecast entity 342 includes available historical data has to be utilized to link history to the predictive/leading drivers, so that both history and the predictive/leading drivers can be utilized create inventory forecasts.

Deriving forecasts by mixing heterogeneous variables 343 includes techniques to mix heterogeneous input data.

Mixing unit and inventory-sensitive forecasts 344 factors in that unit forecasts are sensitive to inventory, and inventory-elasticity. Therefore, known techniques are used for tactical near-term inventory-unit forecast integration.

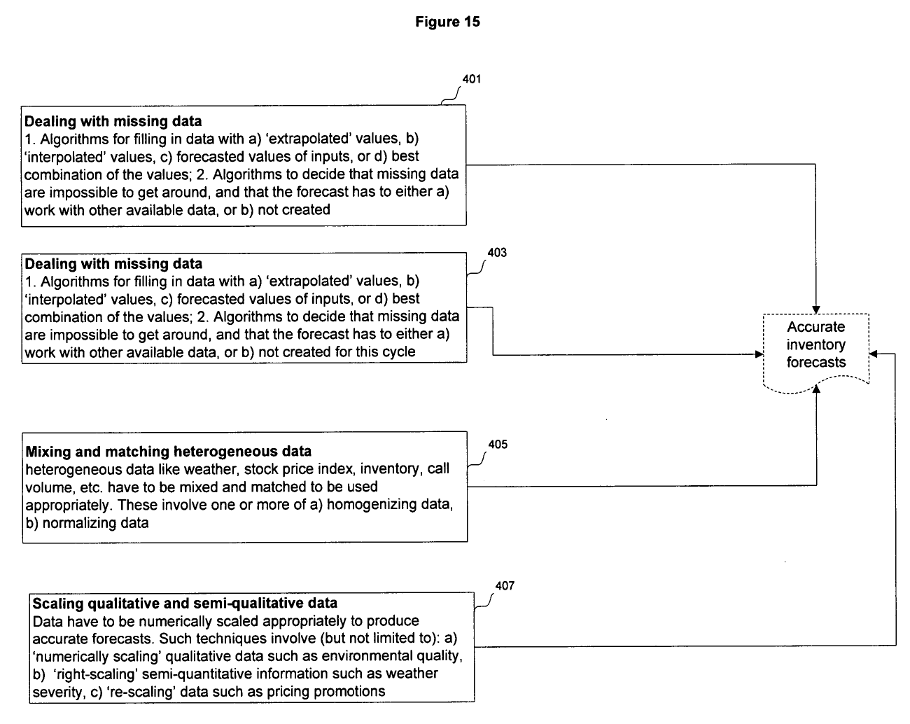

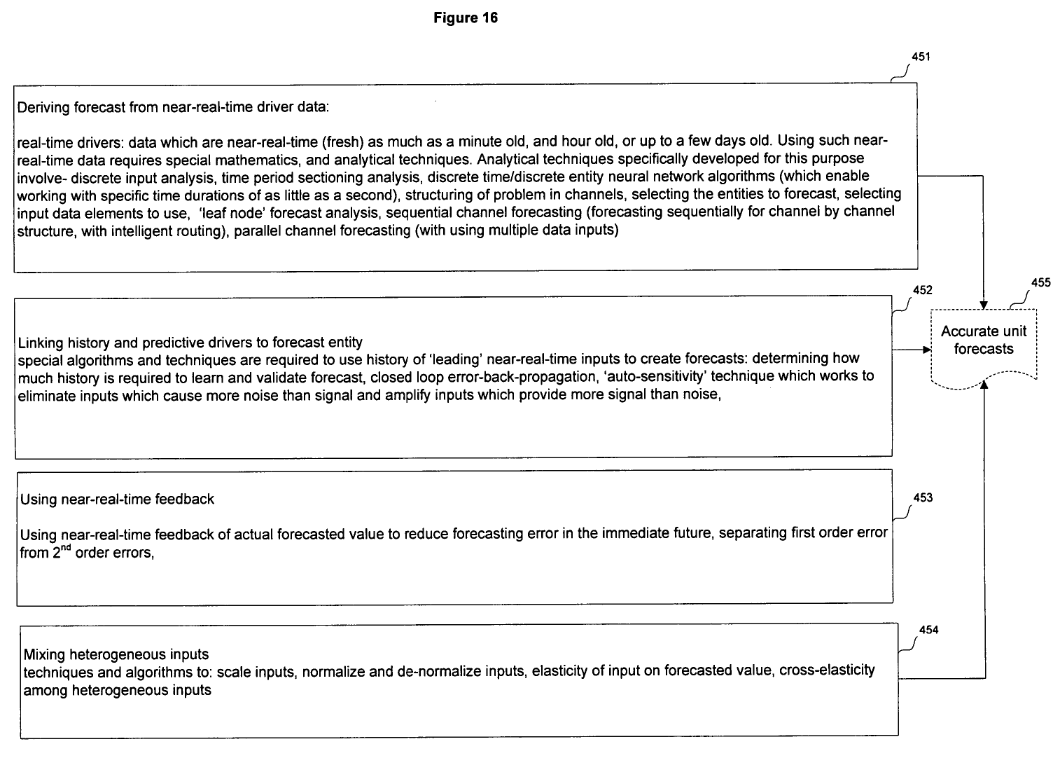

FIG. 15 is a diagram that further illustrates exemplary details of the steps (401, 403, 405, 407) in data transformation process. FIG. 16 is a diagram that illustrates exemplary details in the steps (451, 452, 453, and 454) for analyzing the transformed data to create a forecast.

The invention is described herein with reference to drawings. These drawings illustrate certain details of specific embodiments that implement the systems and methods and programs of the present invention. However, describing the invention with drawings should not be construed as imposing on the invention any limitations that may be present in the drawings. The present invention contemplates methods, systems and program products on any computer readable media for accomplishing its operations. The embodiments of the present invention may be implemented using an existing computer processor, or by a special purpose computer processor incorporated for this or another purpose.

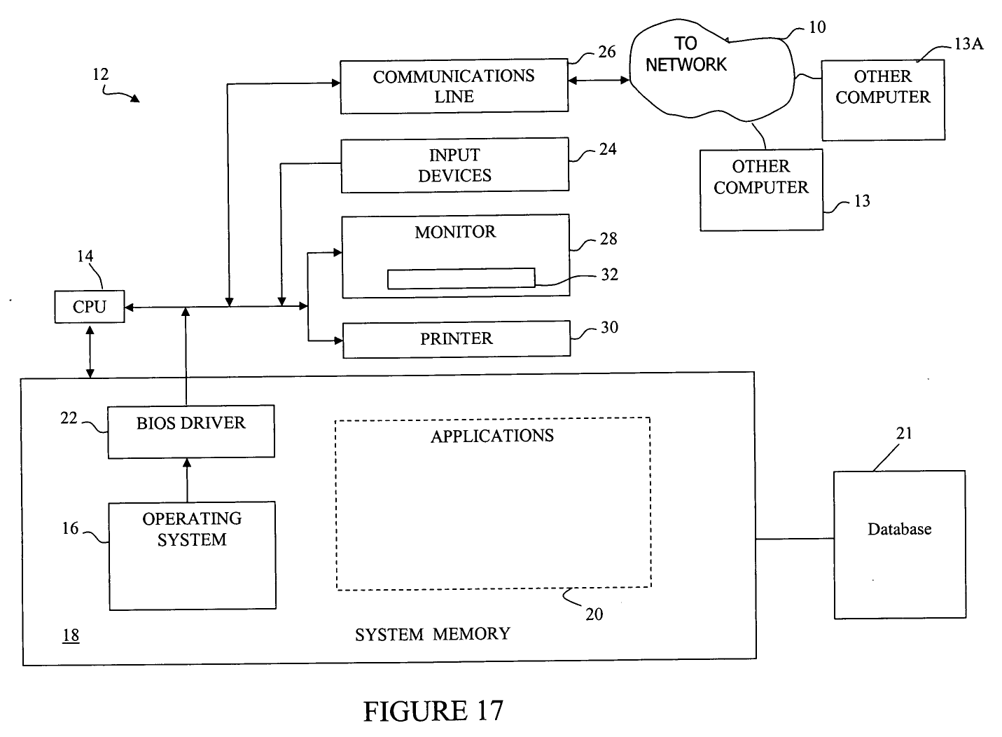

FIG. 17 illustrates the components of a generic computing system connected to a general purpose electronic network 10, such as a computer network. The computer network can be a virtual private network or a public network, such as the Internet. As shown in FIG. 17, the computer system 12 includes a central processing unit (CPU) 14 connected to a system memory 18. The system memory 18 typically contains an operating system 16, a BIOS driver 22, and application programs 20. In addition, the computer system 12 contains input devices 24 such as a mouse or a keyboard 32, and output devices such as a printer 30 and a display monitor 28, and a permanent data store, such as a database 21. The computer system generally includes a communications interface 26, such as an Ethernet card, to communicate to the electronic network 10. Other computer systems 13 and 13A also connect to the electronic network 10 which can be implemented as a Wide Area Network (WAN) or as an internetwork, such as the Internet. In certain embodiments, such a computer system 12 can be used to implement the third party processing system discussed herein including programmed code that implements the logic and modules discussed herein with respect to FIGS. 1-16. One skilled in the art would recognize that such a computing system maybe logically configured and programmed to perform the processes discussed herein with respect to FIGS. 1-16.

One skilled in the art would recognize that the foregoing describes a typical computer system 12 connected to an electronic network 10. It should be appreciated that many other similar configurations are within the abilities of one skilled in the art and it is contemplated that all of these configurations could be used with the methods and systems of the present invention. Furthermore, it should be appreciated that it is within the abilities of one skilled in the art to program and configure a networked computer system to implement the method steps of certain embodiments of the present invention, discussed herein.

As noted above, embodiments within the scope of the present invention include program products comprising computer-readable media for carrying or having computer-executable instructions or data structures stored thereon. Such computer-readable media can be any available media which can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above are also be included within the scope of computer-readable media. Computer-executable instructions comprise, for example, instructions and data which cause a general purpose computer, special purpose computer, or special purpose processing device to perform a certain function or group of functions.

The invention is described in the general context of method steps which may be implemented in one embodiment by a program product including computer-executable instructions, such as program code, executed by computers in networked environments. Generally, program code include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

The present invention in some embodiments, may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Other embodiments of the invention will be apparent to those skilled in the art from a consideration of the specification and the practice of the invention disclosed herein. It is intended that the specification be considered as exemplary only, with the true scope and spirit of the invention also being indicated by the following claims and equivalents thereof.

1. A computer implemented method of making a short term forecasting using tactical predictors, comprising:
collecting predictor data related to the short term forecast, wherein the collecting predictor data includes identifying driver data that drives the forecast from a group consisting of demand drivers, supply drivers, competitive drivers, and environmental drivers;
transforming the predictor data related to the short term forecast; and
creating the short term forecast based on the transformed predictor data.

2. The computer implemented method according to claim 1, wherein the step of collecting predictor data comprises identifying demand drivers that influence demand timing or quantity of items being forecast, identifying supply drivers that directly influence supply timing or quantity of items being forecast, identifying competitive drivers representing competitor data that influences the items being forecast, and environmental drivers that represent environmental data that influences the supply, demand, or pricing of the items being forecast.

3. The computer implemented method according to claim 1, wherein the step of collecting predictor data comprises selecting input data by determining the sensitivity of the forecast to the individual inputs and eliminating inputs that are correlated to the most sensitive inputs.

4. The computer implemented method according to claim 3, wherein the step of transforming the predictor data comprises processing the input data by one or more among a group consisting of: inter-variable processing, asynchronous input presentation, relative gradient inputs, stretching and scaling, cross-normalization, and adjusting non-zero values.

5. The computer implemented method according to claim 1, wherein the step of creating the short term forecast comprises using an algorithm with lateral/simultaneous data input and using gradient tapping to determine a number of periods of data to be used.

6. The computer implemented method according to claim 5, wherein the step of creating the short term forecast further comprises performing parameter optimization.

7. The computer implemented method according to claim 6, wherein the step of performing parameter optimization comprises training based optimization in which all of the training data is used to train a model that creates the forecast.

8. The computer implemented method according to claim 5, wherein the step of creating the short term forecast comprises using longer term forecasts as inputs into shorter term forecasts.

9. The computer implemented method according to claim 7, wherein the step of creating the short term forecast comprises using a relative gradient input from the longer term forecast into the shorter term forecast.

10. The computer implemented method according to claim 8, wherein the step of using longer term forecasts as inputs into shorter term forecasts comprises aggregating the longest term forecasts to a higher level of aggregation.

11. A system for making a short term forecasting using tactical predictors, comprising:
predictor data unit configured to collect predictor data related to the short term forecast, wherein collecting predictor data includes identifying driver data that drives the forecast from a group consisting of demand drivers, supply drivers, competitive drivers, and environmental drivers;
data transformation unit that transforms the predictor data related to the short term forecast; and
forecast creation unit configured to create the short term forecast based on the transformed predictor data.

12. A computer program product on a computer readable medium, that when executed on a computing system, generates a short term forecast using tactical predictors, comprising:
code for collecting predictor data related to the short term forecast, wherein the collecting predictor data includes identifying driver data that drives the forecast from a group consisting of demand drivers, supply drivers, competitive drivers, and environmental drivers;
code for transforming the predictor data related to the short term forecast; and
creating the short term forecast based on the transformed predictor data.
